(19) United States
(12) Patent Application Publication
(10) Pub. No.: US 2025/0351100 A1
(43) Pub. Date: Nov. 13, 2025

(54) HANDLING MULTI-MODAL SYNCHRONIZATION

(71) Applicant: Apple Inc., Cupertino, CA (US)

(72) Inventors: Ping-Heng Kuo, London (GB); Sudeep Manithara Vamanan, Nuremberg (DE); Ralf Rossbach, Munich (DE)

(73) Assignee: Apple Inc., Cupertino, CA (US)

(21) Appl. No.: 19/174,788

(22) Filed: Apr. 9, 2025

Related U.S. Application Data
(60) Provisional application No. 63/644,653, filed on May 9, 2024.

(51) Int. Cl. H04W 56/00; H04W 28/02; H04W 28/06

(52) U.S. Cl. CPC H04W 56/0015; H04W 28/0268; H04W 28/06

(57) ABSTRACT

Techniques are described herein for handling multi-modal synchronization. An example method can include processing first information relating to multi-modal synchronization between a first quality of service (QoS) flow and a second QoS flow. The method can further include processing second information indicating whether a packet data unit (PDU) discard is allowed based on a failure of the multi-modal synchronization. The method can further include generating, based on the first information and the second information, third information to configure a PDU discard behavior. The method can further include outputting the third information for transmission to a user equipment (UE).

### CROSS-REFERENCES TO RELATED APPLICATIONS

This application claims the benefit of U.S. Provisional Application No. 63/644,653, filed on May 9, 2024, which is incorporated by reference.

### FIELD

This application relates generally to wireless networks and, in particular, to technologies for handling multi-modal synchronization in said networks.

### BACKGROUND

Cellular communications can be defined in various standards to enable communications between a user equipment and a cellular network. For example, a long-term evolution (LTE) network and Fifth generation mobile network (5G) are wireless standards that aim to improve upon data transmission speed, reliability, availability, and more.

### BRIEF DESCRIPTION OF THE DRAWINGS

FIG. 1 is an illustration of an example quality of service communication between a user equipment (UE) and a core network (CN), according to one or more embodiments.

FIG. 2 is an illustration of an example signaling diagram for communicating discarding behavior, according to one or more embodiments.

FIG. 3 is an illustration of an example signaling diagram for communicating discarding behavior, according to one or more embodiments.

FIG. 4 is an illustration of an example signaling diagram for communicating discarding behavior, according to one or more embodiments.

FIG. 5 is an illustration of a discard timer, according to one or more embodiments.

FIG. 6 is an illustration example data radio bearers (DRBs), according to one or more embodiments.

FIG. 7 is an example process flow for determining a set of delay-critical PDCP SDUs, according to one or more embodiments.

FIG. 8 is an example process flow for indicating whether a UE can discard data subject to a synchronization requirements, according to one or more embodiments.

FIG. 9 is an example process flow for indicating whether a UE can discard data subject to a synchronization requirements, according to one or more embodiments.

FIG. 10 is an example process flow for indicating whether a UE can discard data subject to a synchronization requirements, according to one or more embodiments.

FIG. 11 is an illustration of an example of receive components, in accordance with some embodiments.

FIG. 12 is an illustration of an example of a user equipment, in accordance with some embodiments.

FIG. 13 is an illustration of an example of a network node, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, 5G NR, or 6G. In general, 3GPP access refers to various types of cellular access technologies.

The term “Non-3GPP Access” refers to any accesses (e.g., radio access technologies) that are not specified by 3GPP standards. These accesses include, but are not limited to, WiMAX, CDMA2000, Wi-Fi, WLAN, or fixed networks. Non-3GPP accesses may be split into two categories, “trusted” and “untrusted.” Trusted non-3GPP accesses can interact directly with an evolved packet core (EPC) or a 5G core (5GC), whereas untrusted non-3GPP accesses interwork with the EPC/5GC via a network entity, such as an Evolved Packet Data Gateway or a 5G NR gateway. In general, non-3GPP access refers to various types on non-cellular access technologies.

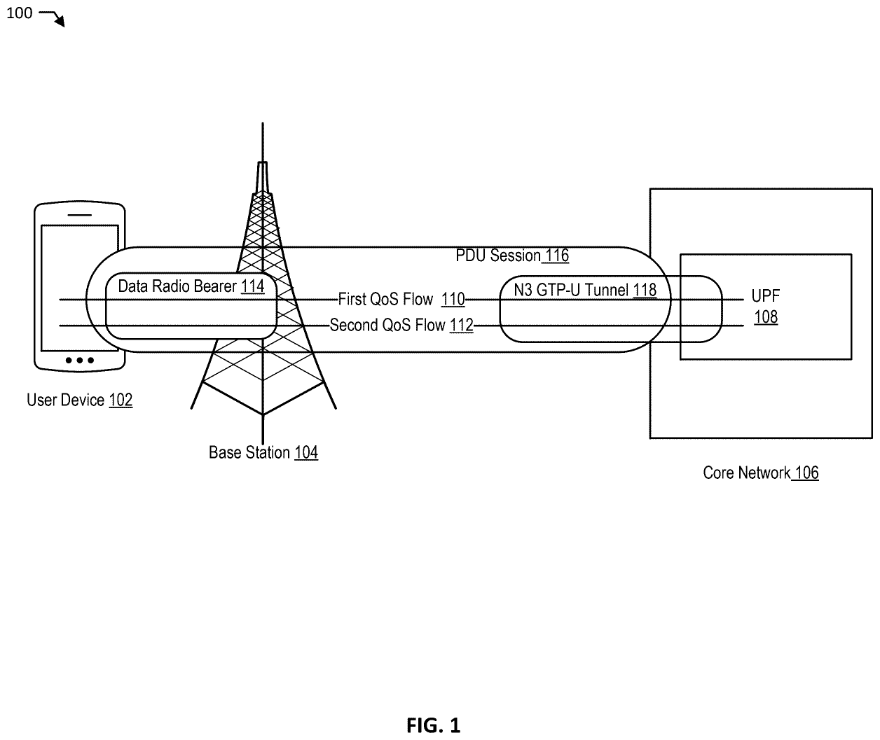

FIG. 1 is an illustration 100 of a quality of service (QoS) communication between a user equipment (UE) and a core network (CN), according to one or more embodiments. As illustrated, a UE 102 is in communication with base station 104 and a CN 106, and in particular a user plane function (UPF) 108. A QoS flow can allow the CN 106 to enforce policy for the UE 102. Additionally, one or more service data flows (SDFs) can be transported via a QoS flow (e.g. first QoS flow 120, second QoS flow 122), in the instance that the QoS flows share the same policy and charging. The base station 104 can map QoS flows (e.g., first QoS flow 120, second QoS flow 122) to a data radio bearer (DRB) 124. Although a single DRB 124 is illustrated for the packet data unit (PDU) session, the base station 104 can map QoS flows to multiple DRBs in the same PDU session 126. Therefore, in other instances, the second QoS flow 122 could be mapped to a second DRB. Or the base station 104 maps the first QoS flow 120 and the second QoS flow 122 to the DRB 124 and maps a third QoS flow to a second DRB. Each DRB in the PDU session 126 can be mapped to a N3 general packet radio service (GPRS) tunneling protocol (GTP)-U tunnel 128.

The PDU session 126 can be used to transport extended reality (XR) information, which can include augmented reality (AR), virtual reality (VR), mixed reality (MR), and combinations thereof. XR applications can be used on a UE, such as a smartphone, wearable device, virtual assistant, or other UE. XR applications can receive inputs from various devices, such as microphones, smartphone cameras, wearable devices, cameras, virtual assistants, or haptic devices. For example, a microphone can provide audio data that can be used to determine biometrics, words, and emotions. A smartphone camera can be used to provide image data used to determine biometrics from the face, emotions from the face, and lip movements. A wearable device can provide data used to determine emotions and haptic information. A camera can provide image data for determining gestures and relative location. A virtual assistant can provide data for determining ambient information. The information from one or more devices can be provide to a service (e.g., a biometric recognition service, an intention perception service, and a device service). For example, the biometric service can be used to determine biometric features of a user. The intention perception service can include a multi-modality natural language processing (NLP) detection feature, a multi-modality emotion detection feature, a multi-modality haptic information detection feature. The device service can be used to cause various multi-modal outputs, for example, control a robot based on haptic information, adjust the settings of an appliance, change a room temperature, or adjust audio visual settings for a device. According to 3GPP TS 22.261 v. 19.6.0 (2024-03), a multi-modal communication service should be provided by 5GS to support various use cases, including XR. In particular, the applications should be able to obtain inputs from more than one source or output to more than one destination to convey the information effectively.

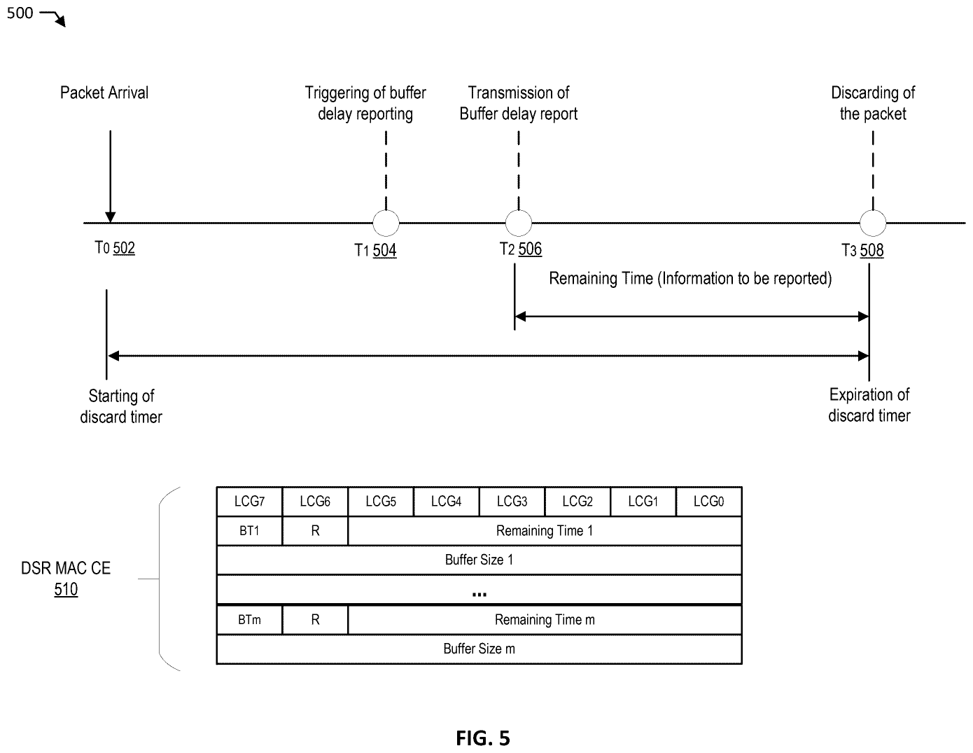

Various protocols can be used to assist an XR application with different features. For example, a packet data convergence protocol (PDCP) layer can be associated with a discard timer for data packets that are received either received via a downlink (DL) communication or to be transmitted via an uplink (UL) communication for an XR application. In order to assist delay-aware scheduling for XR enabled applications running on the UE 102, mechanisms for delay status reporting (DSR) have been specified in 3GPP Rel-18. For example, the discard timer can be utilized to determine when to discard data stored in a buffer. A delay status report (DSR) medium access control (MAC) control element (CE) can be triggered at the UE 102 when the amount time remaining before the discard timer expires in a logical channel (LCH) or logical channel group (LCG) satisfies a remaining time threshold. In response to the MAC CE, the base station 104 can provide the UE 102 with resources to transmit the data prior to expiration of the discard timer. If the UE 102 is unable to transmit the data prior to expiration of the discard timer, the data can be discarded. A discard timer is described in more detail with respect to FIG. 5.

A DSR MAC CE can include a report that includes information of the time remaining until the discard timer expiry. In some instances, the reference point indicated in the report is the starting of the uplink (UL)-shared channel (SCH) for such DSR MAC CE, as well as the data volume (e.g. buffer size) account for the time remaining on the discard timer. The DSR MAC CE structure was adopted in Release-18 (3GPP TS 38.321 V18.1.0 (2024-03)).

In Release-18, 3GPP TS 38.323 V18.0.0 (2023-12) (CR: R2-2313697) the term “Delay-Critical PDCP SDUs” is introduced. A delay-critical PDCP SDU is defined as: if pdu-SetDiscard is not configured, a PDCP SDU for which the remaining time till discardTimer expiry is less than the remaining TimeThreshold. If pdu-SetDiscard is configured, a PDCP SDU belonging to a PDU Set of which at least one PDCP SDU has the remaining time till discardTimer expiry less than the remaining TimeThreshold.

One purpose for “Delay-Critical PDCP SDU” in TS 38.323 is to calculate buffer size for the DSR MAC CE. The relevant data to be used to calculate the buffer size can include (1) delay-critical PDCP service data units (SDUs) for which no PDCP data packet data units (PDUs) have been constructed, (2) PDCP data PDUs that contain only delay-critical PDCP SDUs and have not been submitted to lower layers, (3) PDCP control PDUs, (4) for AM data radio bearers (DRBs) the PCD SDUs can be retransmitted according to clause 5.1.2 and clause 5.1.3 of 3GPP TS 38.323. Furthermore, if a PDCP SDU become a delay-critical PDCP SDU, and if the corresponding PDCP Data PDU has already been submitted to the lower layers, the delay critical indication for the PDCP DAT PDU is provide to the lower layers.

Similarly, Release-18 3GPP TS 38.322 V18.0.0 (2023-12) (CR: R2-2313692) uses a new term “Delay-Critical RLC SDUs.” Delay-Critical RLC SDUs Delay-critical radio link control (RLC) SDU: RLC SDU corresponding to a PDCP PDU indicated as delay-critical by PDCP.

3GPP TS 38.322 defines data volume calculation as follows. For the purpose of MAC buffer status reporting, the UE shall consider as RLC data volume: (1) RLC SDUs and RLC SDU segments that have not yet been included in an RLC data PDU, (2) RLC data PDUs that are pending for initial transmission, and (3) RLC data PDUs that are pending for retransmission. Furthermore, for the purpose of MAC delay status reporting, the UE shall consider the following as delay critical RLC data volume: (1) delay-critical RLC SDUs and delay-critical SDU segments that have not yet been included in an RLC data PDU, (2) RLC data PDUs pending for initial transmission, and containing a delay-critical RLC SDU or a delay-critical RLC SDU segment, and (3) RLC data PDUs that are pending for retransmission (RLC AM). Additionally, if a STATUS PDU has been triggered and t-StatusProhibit is not running or has expired, the UE shall estimate the size of the STATUS PDU that will be transmitted in the next transmission opportunity, and consider this as part of RLC data volume for MAC buffer status reporting and as part of delay-critical RLC data volume for MAC DSR.

For applications, such as immersive VR, different multi-modal data (e.g., audio data and image data) should be synchronized to optimize a user's experience. A synchronization threshold can be defined between two media components (e.g., audio data and image data). For example, table 6.43.1-1 of 3GPP TS 22.261 V19.6.0 (2024-03) has provided various examples for immersive VR applications. Additional background of multi-modal services can be found in 3GPP technical report (TR) 22.847. According to 3GPP TS 23.501 V.18.5.0 (2024-03), to support a synchronization requirement among multiple data flows from different sources, the application function (AF) can provide at the same time, service requirements, for each media that comprise the multi-modal service, a multi-modal service identifier (ID) and a quality of service (QoS) monitoring requirements for multiple internet protocol (IP) data flows associated with a multimodal service. The policy control function (PCF) to derive the correct policy and charging control (PCC) rules and apply QoS policies for data flows that are part of a specific multi-modal application, and generate the authorized QoS monitoring policy for these service data flows. RAN enhancement to address multi-modal synchronization requirements is to be studied in release-19.

In Release-18, an entire PDU set may be discarded by a transmitter when at least one packet in this PDU set is lost or discarded. Such behavior could be configured and enabled when an application can only make use of a PDU set when every single packet of the PDU set is delivered. For multi-modal synchronization, the multi-modal data instances (e.g., image data and audio data) data may have failed to achieve a multi-modal synchronization requirement. For example, the multi-modal data cannot be delivered in accordance with a synchronization deadline. In another example, multi-modal data from one flow that needs to be synchronized with the data from another flow is discarded or lost.

For multi-modal synchronization, the following examples can be contemplated. In a first example, a multi-modal application cannot make use of the data from a flow when the data is failed to achieve the multi-modal synchronization requirement with respect to another flow. In this example, the transmitter (e.g., UE 102) may be configured to discard packets that can no longer fulfil the synchronization requirement, because delivering such packets are not useful for the application anyway. In a second example, the multi-modal application can still make use of the data from a flow, when the data is failed to achieve the multi-modal synchronization requirement.

Contributions submitted to RAN2 #125bis (Apr/2024) have suggested that QoS flows with synchronization requirement should be mapped to the same DRB (e.g., R2-2402278, R2-2402443, and R2-2402841). In addition, contributions have proposed delay-status reporting (DSR) enhancements that takes multi-modal synchronization requirement into account (e.g., R2-2402549, R2-2402953, and R2-2403659). This can facilitate the base station 104 to allocate UL resources that can accommodate all buffered data that have synchronization requirement.

Release-18 has introduced PDU set importance (PSI)-based discarding, in which a DRB is configured with both discardTimer and discardTimerLowImportance. When PSI-based discarding is activated for a DRB, the UE can start a discardTimer for PDCP SDUs belonging to important PDU Sets, and start a discardTimerLowImportance for PDCP SDUs belonging to less-important PDU Sets. The PDCP SDU should be discarded when their respective discardTimer or discardTimerLowImportance is expired.

Various issues can result from the above-described approaches. For example, issues can occur if two packets on the same DRB (e.g., DRB 114) that belong to different QoS flows (e.g., first QoS Flow 110 and second QoS flow 112) have multi-modal synchronization requirement, and have different importance level. In this situation, the issue is how to handle the discard timers when PSI-based discarding is activated. Another issue is how the base station 104 can determine whether a multi-modal application executing on the UE 102 can still make use of the data, when there is a failure of the synchronization requirement.

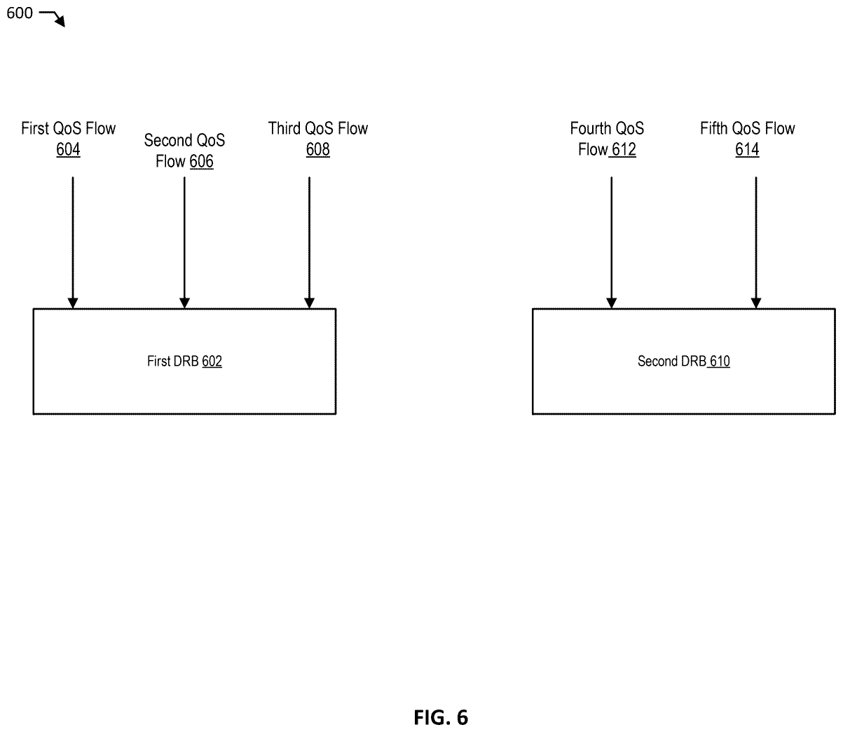

Another issue is that when multiple flows with a synchronization requirement are mapped to the DRB 114, potentially along with QoS flows other than the first QoS flow 110 and the second QoS flow 112 that are not to be synchronized or possibly a different DRB, how can a transmitter identify delay-critical packets for DSR. For example, the base station 104 may have mapped a third QoS flow to the DRB 114, where the third QoS flow is not synchronized with the first QoS flow 110 or the second QoS flow 112. In another example, the first QoS flow 110 and the second QoS flow 112 can be mapped to the DRB 114. Furthermore, the base station 104 may have mapped a third QoS flow to a second DRB, where the QoS flow has a synchronization requirement with the first QoS flow 110 and the second QoS flow. These examples are described with more particularity with respect to FIG. 6. Another issue is how should the UE 102 manage the discard timer values for PDCP SDUs that have synchronization requirement but with different importance levels, when the PSI-based discarding is activated on the DRB.

Embodiments herein address the above referenced issues. Embodiments herein address how the base station 104 can determine whether an application can still make use of the data, when there is a failure of the multi-modal synchronization requirement. The base station 104 may need to be aware whether an application can still make use of the data that is received after the synchronization deadline, or whether an application can still make use of the data associated with one modality when the data associated with another modality is already lost or discarded. In the XR context, a failure of a multi-modal synchronization requirement can occur when data associated with one modality (e.g., audio data) cannot be transmitted within a threshold time of data associated with another modality (e.g., image data, haptic data), or when the data packet associated with one of the modalities is already lost or discarded. If the application cannot make use of the data when the multi-modal synchronization requirement is not fulfilled, transmission of pending packets for another modality that required to be synchronized may no longer be needed. This may provide some opportunities for the RAN to save resource by avoiding unnecessary transmissions.

The base station 104 can obtain the information relating to whether discarding is allowed, where the information can be applicable to either a DL communication or an UL communication. The information can include an indicator as to whether the application layer at the UE 102 can make use of a data unit when the desired synchronization involving this data unit is not achieved (e.g. when a data unit that needs to be synchronized with this data unit is already discarded). This information can be provided by the CN 106 to the base station 104 (e.g., as a part of a QoS parameter). In particular, the application function (AF) can provide this information to the base station 104 provided from the AF via the PCF or SMF. Whether from the PCF or the SMF, the information can be provided to the base station 104. In other instances, this information can be provided by the UE 102 to the base station 104. For example, the information can be provided as a part of UE assistance information (UAI). In some instances, the UE's access stratum (AS) can the information based on an interaction with the application layer. In some embodiments, this information can be referred to as Multi-Modal Service Integrated Handling Information (MMSIHI). Based on such information, the base station 104 can configure the UE 102 to perform discarding based on the dependency among the data flows. For example, in cases where a first flow and a second flow correspond to modalities that are required to be synchronized, the UE 102 may be configured to discard one or more data units on the first flow, when one or more data units on the second flow is discarded (i.e. synchronization can no longer be achieved).

Regardless of whether the information is provided by the UE 102 or the base station 104, the information can be provided per QoS flow, or per a set of QoS flows that have synchronization requirement. For example, the information can be associated with a particular multi-modal service identifier (ID). A multi-modal service ID is defined in 3GPP TS 23.501, which is an explicit indication that data flows are related to a multi-modal service. For example, the QoS flows (e.g., first QoS flow 110 and second QoS flow 112) with the same multi-modal Service ID have synchronization requirement.

In some instances, the discarding dependency among the QoS flows may not be bi-directional. For example, the first QoS flow 110 and the second QoS flow 112 can have a synchronization requirement. In one embodiment, data from both the first QoS flow 110 and the second QoS flow 112 can be discarded when a synchronization requirement between them has failed. In another embodiment, data from the first QoS flow 110 can be discarded, but data from the second QoS flow 112 cannot be discarded, when a synchronization requirement between them has failed. In another embodiment, data from the second QoS flow 112 can be discarded, but data from the first QoS flow 110 cannot be discarded, when a synchronization requirement between them has failed.

In some embodiments, whether discarding data is allowed when synchronization is failed can depend on the importance of the data. For example, a data packet can be discarded, if the data packet belongs to a less-important PDU Set, otherwise the data packet cannot be discarded. The base station 104 can use the information provided by either the UE 102 or the CN 106 to can configure/enable the discarding behavior for the corresponding DRB (e.g., DRB 114) when a synchronization requirement between specific packets/flows has failed. The discarding behavior can include, for example, discarding a first PDU packet from a first QoS flow when a PDU packet from a second PDU packet is discarded, given that there is a synchronization requirement between the flows. The discarding behavior can also include continuing a transmission of the PDU packet from the first QoS flow when a PDU packet from the second QoS flow is discarded, given that there is a synchronization requirement between the flows.

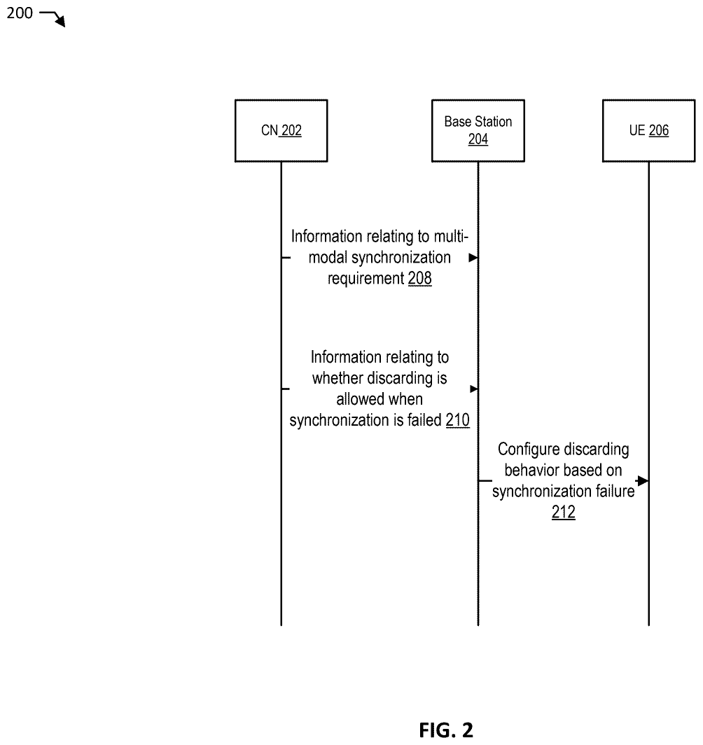

FIG. 2 is an illustration 200 of an example signaling diagram for communicating discarding behavior, according to one or more embodiments. As illustrated a CN 202 (e.g., CN 106) is in communication with a base station 204 (e.g., base station 104) and a UE 206 (e.g., UE 102). At 208, the CN 202 can transmit information relating to a multi-model synchronization requirement to the base station 204. The information can include, for example, that data transported in one QoS flow (e.g., first QoS flow 110) is to be synchronized with data from another QoS flow (e.g., second QoS flow 112). At 210, the CN 202 can provide information to the base station 204 as to whether discarding is allowed with the synchronization has failed. In some instances, the information can be provided by the CN 202 via the PCF or SMF. At 212, the base station 204 can provide configuration information for discarding behavior based on a synchronization failure to the UE 206.

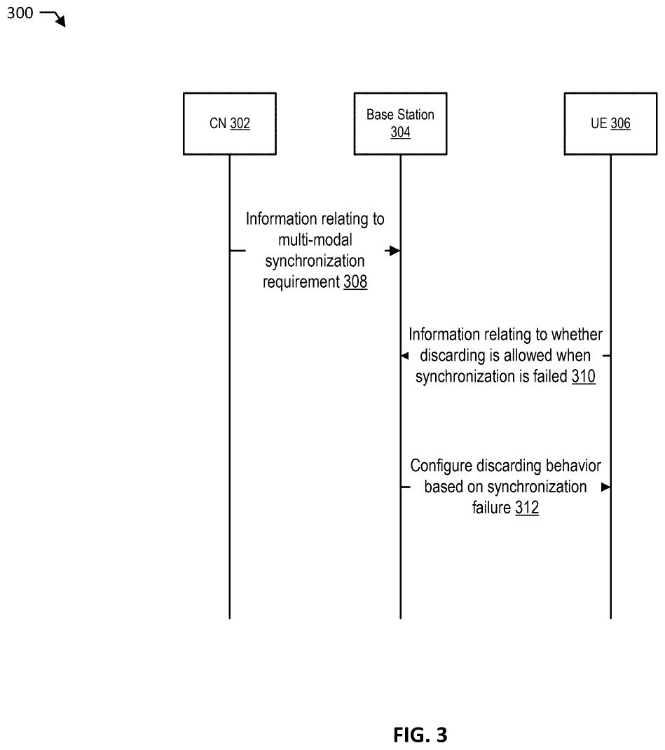

FIG. 3 is an illustration 300 of an example signaling diagram for communicating discarding behavior, according to one or more embodiments. As illustrated a CN 302 (e.g., CN 106) is in communication with a base station 304 (e.g., base station 102) and a UE 306 (e.g., UE 102). At 308, the CN 302 can transmit information relating to a multi-model synchronization requirement to the base station 304. The information can include, for example, that data transported in one QoS flow (e.g., first QoS flow 110) is to be synchronized with data from another QoS flow (e.g., second QoS flow 112). At 310, the UE 306 can provide information to the base station 304 as to whether discarding is allowed with the synchronization has failed. In some instances, the information can be provided by the UE 306 to the base station via UAI. At 312, the base station 304 can provide configuration information for discarding behavior based on a synchronization failure to the UE 306.

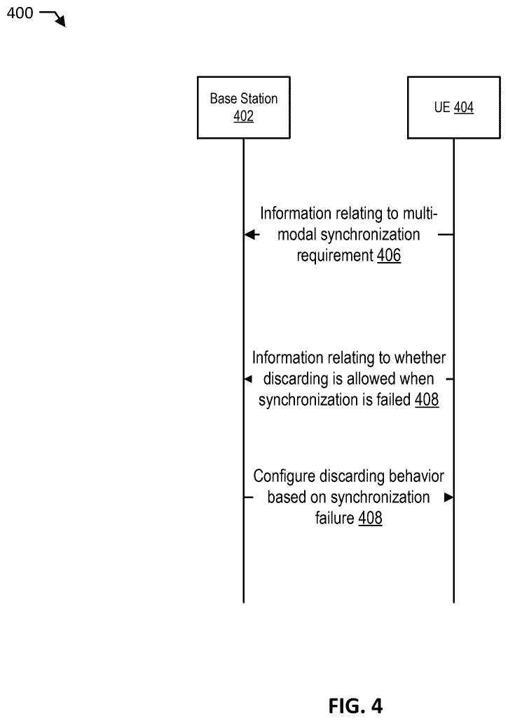

FIG. 4 is an illustration 400 of an example signaling diagram for communicating discarding behavior, according to one or more embodiments. As illustrated a base station 402 (e.g., base station 102) is in communication with a UE 404 (e.g., UE 102). At 406, the UE 404 can transmit information relating to a multi-model synchronization requirement to the base station 402. The information can include, for example, that data transported in one QoS flow (e.g., first QoS flow 110) is to be synchronized with data from another QoS flow (e.g., second QoS flow 112). At 408, the UE 404 can provide information to the base station 402 as to whether discarding is allowed with the synchronization has failed. In some instances, the information can be provided by the UE 404 to the base station via UAI. At 410, the base station 402 can provide configuration information for discarding behavior based on a synchronization failure to the UE 404.

FIGS. 5 and 6 are provided for context as to how can a transmitter identify delay-critical packets for DSR. FIG. 5 is an illustration 500 of an example discard timer, according to one or more embodiments. At T₀ 502, a data packet can arrive at a UE (e.g., UE 102). In some instances, T₀ 502 corresponds to the processing of a data packet at the UE. The data packet can be stored in a buffer. Either based on the arrival of the data packet or the processing of the data packet, the UE can start a discard timer at T₀ 502, At the expiration of the discard timer, if the data packet remains in the buffer, the UE can discard the data packet. At T₁ 504 the UE can be triggered to initiate buffer delay reporting, wherein a buffer delay report can indicate either how long a data packet has remained in a buffer or an amount of time before the discard time expires. At T₂ 506, the UE can transmit the buffer relay report to the base station. In some instances, the UE can initiate and transmit a DSR MAC CE 510. An example DSR MAC CE 510 according to 3GPP 38.321 V18.0.0 is illustrated in FIG. 5. The transmission can include an indication of the time remaining before expiration of the discard timer. Between T₂ 506 and T₃ 508 the base station (e.g., base station 104) can configure resources for the UE to transmit the data packet in the buffer. If the UE receives the resources in time prior to T₃ 508, the UE can transmit the data. If at T₃ 508, the UE has not received resources in time, the UE can discard the data packet.

FIG. 6 is an illustration 600 example data radio bearers (DRBs), according to one or more embodiments. As indicated above, a DRB can be mapped to more than one QoS flow, in which some QoS flows are subset to a synchronization requirement and one or more QoS flows are not subject to any or the same QoS synchronization requirement. Furthermore, in some instances different DRBs are mapped to respective QoS flows that are subject to a synchronization requirement.

As illustrated, a first DRB 602 can be mapped to a first QoS flow 604, a second QoS flow 606, and a third QoS flow 608. A second DRB 610 can be mapped to a fourth QoS flow 612 and a fifth QoS flow 614. Each of the QoS flows can be part of the same PDU session. As an illustrative example, the first QoS flow 604, the second QoS flow 606, and the fourth QoS flow 612 can have the same synchronization requirement. Whereas the third QoS flow 608 and the fifth QoS flow 614 may not have the same synchronization requirement. These QoS flows may have no synchronization requirement or synchronization requirements with QoS flows other than the first QoS flow 604, the second QoS flow 606, and the fourth QoS flow 612. For example, there can be a synchronization requirement between the third QoS flow 608 and the fifth QoS flow 614.

As to how can a transmitter identify delay-critical packets for DSR, the following techniques are described. When the remaining time until expiration of the discard timer for a PDCP SDU is smaller than a threshold, the UE (e.g., UE 102) can identify the delay critical PDCP SDUs based on, for example a PDU Set discarding configuration (see definition in #3GPP TS 38.323). In these instances, the UE can be triggered for DSR.

The UE (e.g., UE 102) can determines whether any delay-critical PDCP SDU belongs to a first QoS flow (e.g., first QoS flow 604) that has multi-modal synchronization requirement with a second QoS flow (e.g., second QoS flow 606). The UE can further determine whether the second QoS flow, that has multi-modal synchronization requirement with the PDCP SDU, is also mapped to the same DRB (e.g., first DRB 602). The UE can further determine whether any PDCP SDU that belongs to the second QoS flow is in the buffer. In addition, the UE can also identify that one or more PDCP SDUs that belongs to the second QoS flow buffered in this DRB as a delay-critical PDCP SDU, even if the remaining time until discard timer expiry for these PDCP SDUs belonging to the second QoS flow is still larger than a threshold. In some embodiments, the UE can identify that the PDCP SDU belongs to a third QoS flow buffered in another DRB as a delay-critical PDCP SDU. The third QoS flow can also have the synchronization requirement with the first QoS flow. For example, referring back to FIG. 6, the fourth QoS flow 612 has the same synchronization requirement as the first QoS flow 604. The UE can calculate the delay-critical data volume for the purpose of DSR based on all the identified delay-critical PDCP SDUs belonging to a plurality of QoS flows with multi-modal synchronization requirement.

As described in 3GPP TS 38.323, for a delay-critical PDCP SDU: if pdu-SetDiscard is not configured, a PDCP SDU for which the remaining time till discardTimer expiry is less than the remainingTimeThreshold. If pdu-SetDiscard is configured, a PDCP SDU belonging to a PDU set of which at least one PDCP SDU has the remaining time till discardTimer expiry less than the remainingTimeThreshold. If multi-modality synchronization requirement is present, a PDCP SDU that belongs to a QoS flow that needs to be synchronized with at least one delay-critical PDCP SDU.

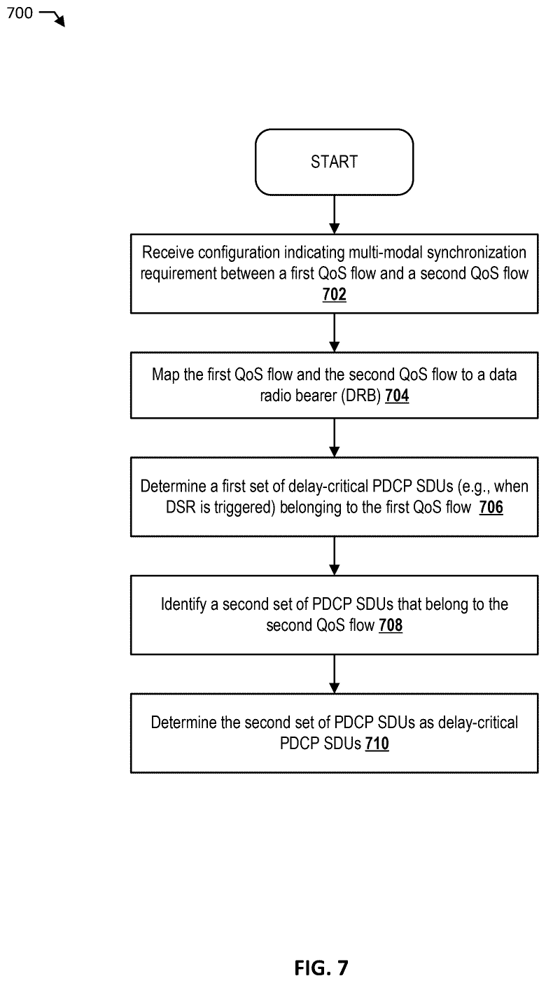

FIG. 7 is an example process flow 700 for determining a set of delay-critical PDCP SDUs, according to one or more embodiments. At 702, a UE can receive configuration information indicating a multi-modal synchronization requirement between a first QoS flow and a second QoS flow. The configuration information can be received by the UE from core network via a base station.

At 704, the UE can map the first QoS flow and the second QoS flow to a DRB. For example, the UE can perform the mapping based on a configuration from a base station.

At 706, the UE can identify a first set of delay-critical PDCP SDUs from PDCP SDUs belonging to the first QoS flow that have arrived in the buffer. For example, the UE can make the determination at the time the DSR is triggered (e.g., T₁ of FIG. 5).

At 708, the UE can identify a second set of PDCP SDUs from PDCP SDUs belonging to the second QoS flow that have arrived in the buffer.

At 710, the UE can determine that the second set of PDCPs as delay-critical PDCP SDUs. The determination can be based on the first QoS flow and the second QoS flow have the same synchronization requirement.

As to how the UE should handle the discard timer values for PDCP SDUs that have synchronization requirement but with different importance levels, the following techniques are described. When PSI-based discarding is activated for a DRB, the UE (e.g., UE 102) can start discardTimer for PDCP SDUs belonging to important PDU sets, and the UE can start discardTimerLowImportance for PDCP SDUs belonging to less-important PDU sets. If two data packets (i.e. PDCP SDUs) are linked based on multi-modal synchronization requirement, and they belong to PDU sets with different importance, the UE may: (1) apply a first discard timer (e.g., discardTimer) to both PDCP SDUs, regardless of their importance, (2) apply a second discard timer (e.g., discardTimerLowImportance) to both PDCP SDUs, regardless of their importance, or (3) apply the second discard timer (e.g., discardTimerLowImportance) to the less important PDCP SDUs, and apply the first discard timer (e.g., discardTimer) to other linked PDCP SDUs (legacy behavior). In these embodiments, the UE can be pre-configured to behave in accordance to one of the options above.

For example, the UE can detect set of first data packets and a second data set of packets in a buffer and identify the importance of the first set of data packets and the importance of the second set of data packets. In some embodiments, the importance of one set of data packets is higher than the importance of the other set of data packets, yet both sets of data packets may have the same synchronization requirements. The UE can further be triggered to start a discard timer (e.g., T₀ of FIG. 5, when the packet is arrived). To determine whether to use the same discard timer (e.g., the first discard timer or the second discard timer) for both sets of data packets or use a different discard timer for each of the sets of data packets, the UE can be configured with one of the three options described above.

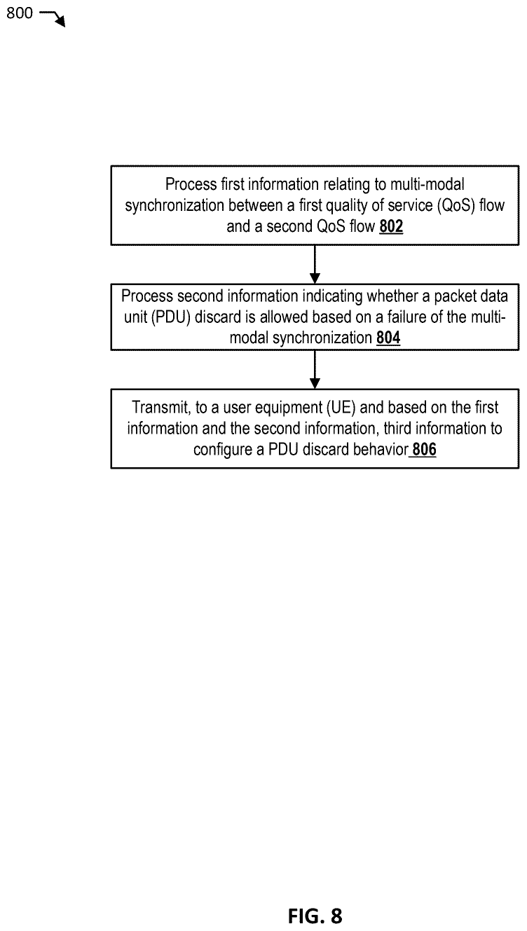

FIG. 8 is an example process flow 800 for indicating whether a UE can discard data subject to a synchronization requirements, according to one or more embodiments. At 802, the method can include a base station processing first information. The first information can relate to multi-modal synchronization between a first QoS flow and a second QoS flow. The first information can be received from a CN or the UE.

At 804, the method can include the base station processing second information indicating whether a PDU discard is allowed based on a failure of the multi-modal synchronization. The second information can be received from the CN, via a PCF or SMF. The second information can also be received from a UE via UAI. In another embodiment the second information can whether an application can only make use of the received packets when the multi-modal synchronization requirement is fulfilled. In this sense, if a base station is aware that the application cannot make use of any received packets when multi-modal synchronization requirement is not fulfilled, then it may configure the discarding behavior where the pending packets involved in failed synchronization are discarded.

At 806, the method can include transmitting, to a UE and based on the first information and the second information, third information to configure a PDU discard behavior. In some embodiments, the third information can include instructing the UE to take a data importance into account to determine whether to discard the data.

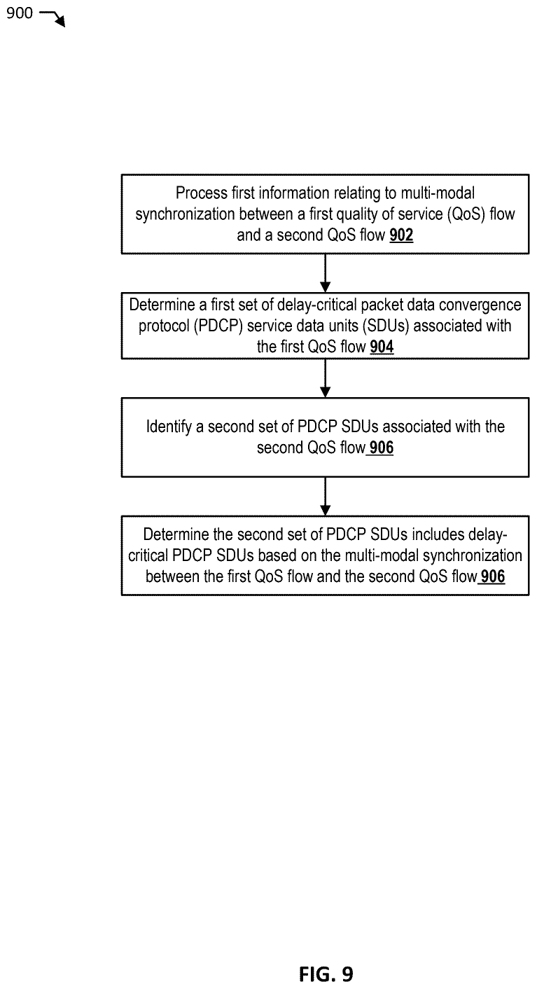

FIG. 9 is an example process flow 900 for indicating whether a UE can discard data subject to a synchronization requirements, according to one or more embodiments. At 902, the method can include processing first information relating to multi-modal synchronization between a first QoS flow and a second QoS flow. The first QoS flow and the second QoS flow can be mapped to a DRB.

At 904, the method can include determining a first set of delay-critical PDCP SDUs associated with the first QoS flow. The first set of delay-critical PDCP SDUs can be stored in a buffer.

At 906, the method can include identifying a second set of PDCP SDUs associated with the second QoS flow. The second set of delay-critical PDCP SDUs can also be stored in the buffer.

At 908, the method can include determining the second set of PDCP SDUs includes delay-critical PDCP SDUs based on the multi-modal synchronization between the first QoS flow and the second QoS flow. A discard behavior for discarding the packets can be based on both the first and second set of PDCP SDUs being considered as delay-critical.

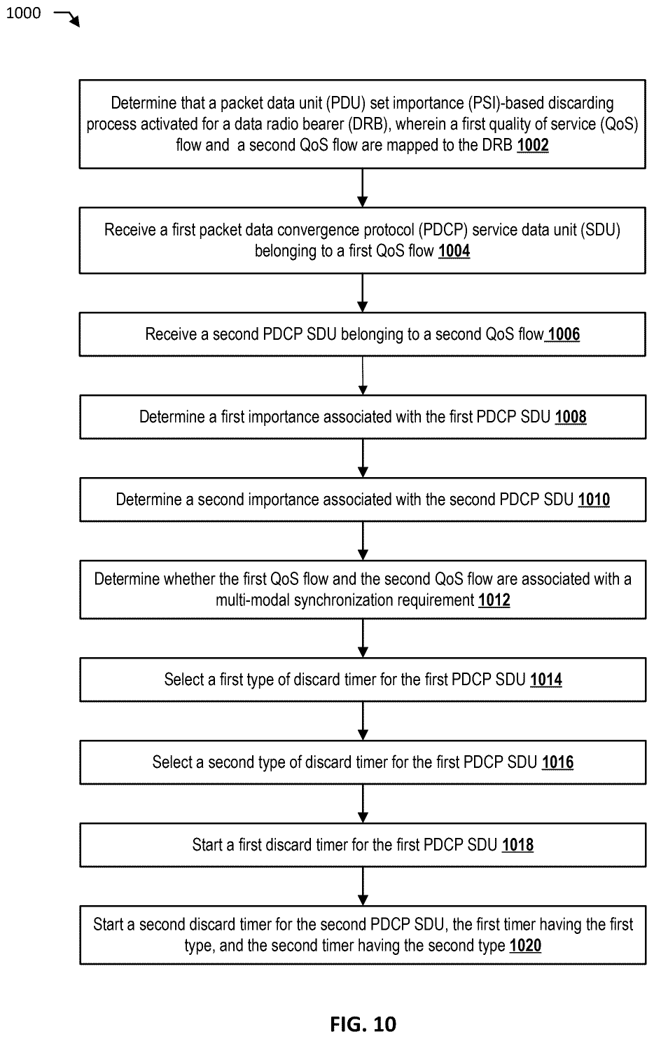

FIG. 10 is an example process flow 1000 for indicating whether a UE can discard data subject to a synchronization requirements, according to one or more embodiments. At 1002, the method can include determining that a packet data unit (PDU) set importance (PSI)-based discarding process activated for a data radio bearer (DRB). A first quality of service (QOS) flow and a second QoS flow can be mapped to the DRB. The first QoS flow and the second QoS flow can be associated with a multi-modal synchronization.

At 1004, the method can include receiving a first packet data convergence protocol (PDCP) service data unit (SDU) belonging to the first QoS flow. At 1006, the method can include receiving a second PDCP SDU belonging to the second QoS flow.

At 1008, the method can include determining a first importance associated with the first PDCP SDU. At 1010, the method can include determining a second importance associated with the second PDCP SDU. At 1012, the method can include determining whether the first QoS flow and the second QoS flow are associated with a multi-modal synchronization requirement.

At 1014, the method can include selecting a first type of discard timer for the first PDCP SDU. At 1016, the method can include selecting a second type of discard timer the second PDCP SDU. The discard timer can be a first discard timer (e.g., discardTimer) associated with PDCP SDUs of importance. The discard timer can also be a second discard timer (e.g., discardTimerLowImportance) associated with PDCP SDUs of less importance. The first set of PDCP SDUs can be of importance or less importance.

At 1018, the method can include starting a first discard timer for the first PDCP SDU. At 1020, the method can include starting a second discard timer for the second PDCP SDU, the first timer having the first type, and the second timer having the second type.

In some instances. the first type of discard timer is a discard timer for PDCP SDUs belonging to important PDU sets. The second type of discard timer is also the discard timer for PDCP SDUs belonging to important PDU sets. In these instances, the first QoS flow and the second QoS flow are determined to be associated with the multi-modal synchronization requirement. The discard timer selection can be regardless of the first importance and the second importance.

In some instances. the first type of discard timer is a discard timer for PDCP SDUs belonging to less important PDU sets. The second type of discard timer is also the discard timer for PDCP SDUs belonging to less important PDU sets. In these instances, the first QoS flow and the second QoS flow are determined to be associated with the multi-modal synchronization requirement. The discard timer selection can be regardless of the first importance and the second importance.

In some instances, the first type of discard timer is a discard timer for PDCP SDUs belonging to important PDU sets. The second type of discard timer is a discard timer for PDCP SDUs belonging to less important PDU sets The first QoS flow and the second QoS flow are determined to be associated with the multi-modal synchronization requirement.

In some embodiments a method can include determining that a PDU set importance (PSI)-based discarding process activated for a DRB. A first quality of service (QoS) flow and a second QoS flow can be mapped to the DRB. The method can further include receiving a first packet data convergence protocol (PDCP) service data unit (SDU) belonging to a first QoS flow. The method can further include determining a first importance associated with the first PDCP SDU. The method can further include selecting a first discard timer for the first PDCP SDU based on the first importance. The method can further include starting a first discard timer for the first PDCP SDU. The method can further include receiving a second PDCP SDU belonging to a second QoS flow. The method can further include determining a second importance associated with the second PDCP SDU. The method can further include selecting a second discard timer for the second PDCP SDU based on at least one of: whether the first QoS flow and the second QoS flow are associated with a multi-modal synchronization requirement, or the second importance. The method can further include starting the second discard timer for the second PDCP SDU.

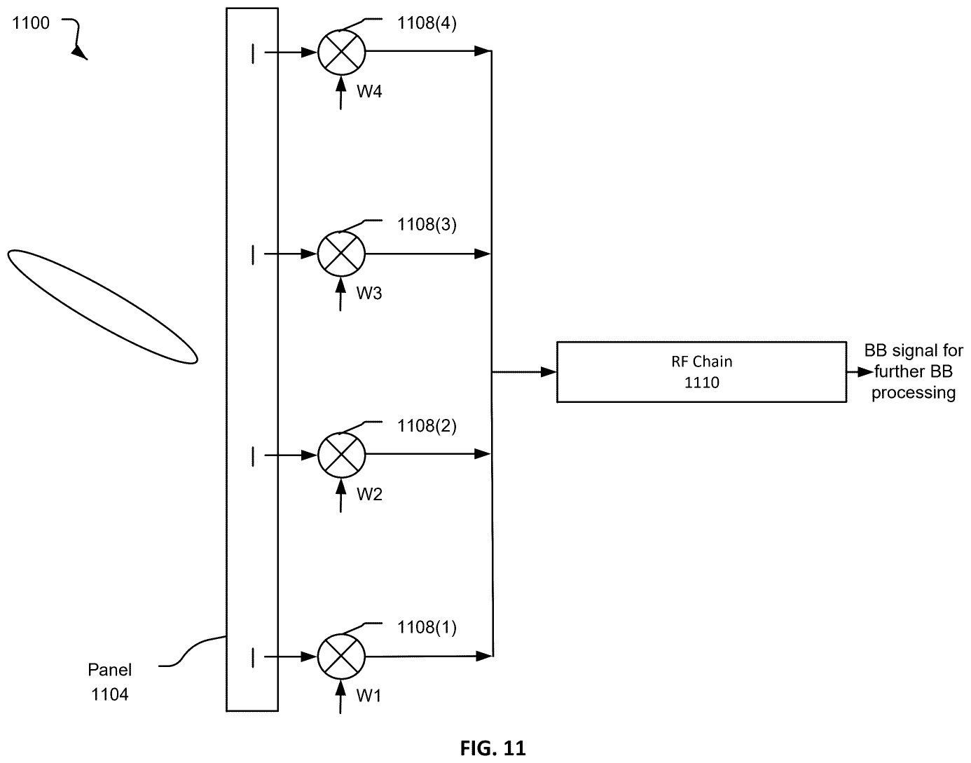

FIG. 11 illustrates receive components 1000 of the UE 1106, in accordance with some embodiments. The receive components 1100 may include an antenna panel 1104 that includes a number of antenna elements. The panel 1104 is shown with four antenna elements, but other embodiments may include other numbers.

The antenna panel 1104 may be coupled to analog beamforming (BF) components that include a number of phase shifters 1108(1)-1108(4). The phase shifters 1108(1)-1108(4) may be coupled with a radio-frequency (RF) chain 1113. The RF chain 1113 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (e.g., W1-W4), which may represent phase shift values, to the phase shifters 1108(1)-1108(4) to provide a receive beam at the antenna panel 1104. These BF weights may be determined based on the channel-based beamforming.

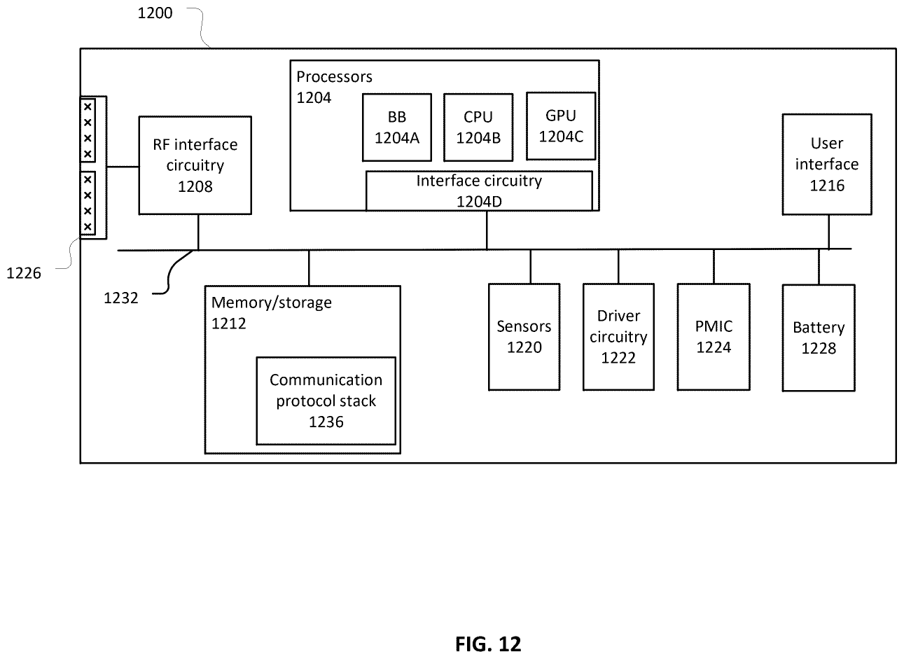

FIG. 12 illustrates a UE 1200, in accordance with some embodiments. The UE 1200 may be similar to and substantially interchangeable with UE 102 of FIG. 1.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage 1212 to cause the UE 1200 to perform delay-adaptive operations as described herein. The processors 1204 may also include interface circuitry 1204D to communicatively couple the processor circuitry with one or more other components of the UE 1200.

In some embodiments, the baseband processor circuitry 1204A may access a communication protocol stack 1236 in the memory/storage 1212 to communicate over a 3GPP compatible network. In general, the baseband processor circuitry 1204A may access the communication protocol stack 1236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1208.

The baseband processor circuitry 1204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1212 may include one or more non-transitory, computer-readable media that includes instructions (for example, communication protocol stack 1236) that may be executed by one or more of the processors 1204 to cause the UE 1200 to perform various delay-adaptive operations described herein.

The memory/storage 1212 includes any type of volatile or non-volatile memory that may be distributed throughout the UE 1200. In some embodiments, some of the memory/storage 1212 may be located on the processors 1204 themselves (for example, memory/storage 1212 may be part of a chipset that corresponds to the baseband processor circuitry 1204A), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1208 may include transceiver circuitry and a radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1226 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1226.

In various embodiments, the RF interface circuitry 1208 may be configured to transmit/receive signals in a manner compatible with NR access technologies.

The antenna 1226 may include antenna elements to convert electrical signals into radio waves to travel through the air and to convert received radio waves into electrical signals. The antenna elements may be arranged into one or more antenna panels. The antenna 1226 may have antenna panels that are omnidirectional, directional, or a combination thereof to enable beamforming and multiple input, multiple output communications. The antenna 1226 may include microstrip antennas, printed antennas fabricated on the surface of one or more printed circuit boards, patch antennas, or phased array antennas. The antenna 1226 may have one or more panels designed for specific frequency bands including bands in FR1 or FR2.

The user interface 1216 includes various input/output (I/O) devices designed to enable user interaction with the UE 1200. The user interface 1216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1200.

The sensors 1220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various input/output (I/O) devices that may be present within, or connected to, the UE 1200. For example, driver circuitry 1222 may include a display driver to control and allow access to a display device, a touchscreen driver to control and allow access to a touchscreen interface, sensor drivers to obtain sensor readings of sensors 1220 and control and allow access to sensors 1220, drivers to obtain actuator positions of electro-mechanic components or control and allow access to the electro- mechanic components, a camera driver to control and allow access to an embedded image capture device, audio drivers to control and allow access to one or more audio devices.

The PMIC 1224 may manage power provided to various components of the UE 1200. In particular, with respect to the processors 1204, the PMIC 1224 may control power-source selection, voltage scaling, battery charging, or DC-to-DC conversion.

A battery 1228 may power the UE 1200, although in some examples the UE 1200 may be mounted deployed in a fixed location and may have a power supply coupled to an electrical grid. The battery 1228 may be a lithium ion battery, a metal-air battery, such as a zinc-air battery, an aluminum-air battery, a lithium-air battery, and the like. In some implementations, such as in vehicle-based applications, the battery 1228 may be a typical lead-acid automotive battery.

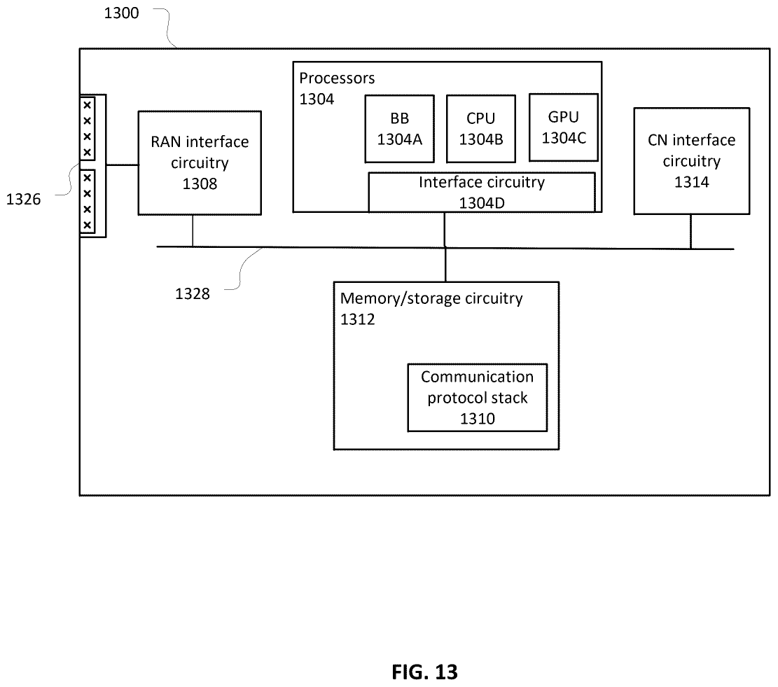

FIG. 13 illustrates a network device 1300 in accordance with some embodiments. The network device 1300 may be similar to and substantially interchangeable with base station or a device of the core network or external data network.

The network device 1300 may include processors 1304, RF interface circuitry 1308 (if implemented as a base station), core network (CN) interface circuitry 1314, memory/storage circuitry 1312, and antenna structure 1326.

The components of the network device 1300 may be coupled with various other components over one or more interconnects 1328.

The processors 1304, RF interface circuitry 1308, memory/storage circuitry 1312 (including communication protocol stack 1310), antenna structure 1326, and interconnects 1328 may be similar to like-named elements shown and described with respect to FIG. 12.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage circuitry 1312 to cause the UE to perform delay-adaptive operations as described herein. The processors 1304 may also include interface circuitry 1304D to communicatively couple the processor circuitry with one or more other components of the network device 1300.

The CN interface circuitry 1314 may provide connectivity to a core network, for example, a 5th Generation Core network (5GC) using a 5GC-compatible network interface protocol such as carrier Ethernet protocols, or some other suitable protocol. Network connectivity may be provided to/from the network device 1300 via a fiber optic or wireless backhaul. The CN interface circuitry 1314 may include one or more dedicated processors or FPGAs to communicate using one or more of the aforementioned protocols. In some implementations, the CN interface circuitry 1314 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further example embodiments are provided.

Example 1 includes a method comprising: processing first information relating to multi-modal synchronization between a first QoS flow and a second QoS flow; processing second information indicating whether a PDU discard is allowed based on a failure of the multi-modal synchronization; and transmitting, to a UE and based on the first information and the second information, third information to configure a PDU discard behavior.

Example 2 includes the method of example 1, wherein the second information is received from a CN via a PCF or a session management function SMF.

Example 3 includes the method of example 2, wherein the method further comprises: receiving the second information from an AF via a PCF or an SMF.

Example 4 includes the method of any of examples 1-3, wherein the first information is received from a core network.

Example 5 includes the method of any of examples 1-3, wherein the first information is received from the UE.

Example 6 includes method of examples 1, 4, or 5, wherein the second information is received from the UE via UAI.

Example 7 includes the method of any of examples 1-6, further comprising: obtaining, from the first information, a multi-modal service ID associated with both the first QOS flow and the second QOS flow; and determining the multi-modal synchronization between the first QoS flow and the second QoS flow based on the multi-modal service ID being associated with both the first QoS flow and the second QoS flow.

Example 8 includes the method of any of examples 1-7, wherein the first information is to configure the PDU discard behavior when a failure of the multi-modal synchronization is detected and the PDU discard behavior comprises: discarding a first PDU packet from the first QoS flow when a PDU packet from the second QoS flow is discarded.

Example 9 includes the method of any of examples 1-7, wherein the first information is to configure the PDU discard behavior when a failure of the multi-modal synchronization is detected and the PDU discard behavior comprises: continuing a transmission of the PDU packet from the first QoS flow when a PDU packet from the second QoS flow is discarded;

Example 10 includes the method of any of examples 1-9, wherein the method further comprises: determining whether to discard a first PDU packet belonging to the first QoS flow or a second PDU belonging to the second QoS flow based on a first importance level of the first PDU packet or a second importance of the second PDU packet.

Example 11 includes the method of any of examples 1-10, wherein the method further comprises: mapping the first QoS flow and the second QoS flow to a data radio bearer (DRB); and configuring the DRB based on the PDU discard behavior.

Example 12 includes a baseband processor comprising: processing circuitry to perform and of the steps of examples 1-11; and interface circuitry coupled with the processing circuitry, the interface circuitry to communicatively couple the processing circuitry with a component of a device.

Example 13 includes one or more computer-readable storage media having instructions that, when executed processing circuitry to perform the steps of any of examples 1-11.

Example 14 includes a method comprising: processing first information relating to multi-modal synchronization between a first QoS flow and a second QoS flow; determining a first set of delay-critical PDCP SDUs associated with the first QoS flow; identifying a second set of PDCP SDUs associated with the second QoS flow; and determining the second set of PDCP SDUs includes delay-critical PDCP SDUs based on the multi-modal synchronization between the first QoS flow and the second QoS flow.

Example 15 includes the method of example 14, wherein the method further comprises: mapping the first QoS flow and the second QoS flow to a data radio bearer (DRB).

Example 16 includes the method of examples 14 or 15, wherein the method further comprises: determining that a remaining time until expiration of a discard timer associated with the first set of delay-critical PDCP SDUs is less than a threshold, wherein the UE determines the first set of delay-critical PDCP SDUs based on the remaining time until expiration of the discard timer being less than the threshold.

Example 17 includes the method of examples 14-16, wherein the method further comprises: processing second information indicating the multi-modal synchronization between the first QoS flow and a third QoS flow, wherein the third QoS flow is associated with a third set of PDCP SDUs, wherein the first QoS flow and the second QoS flow are mapped to a first DRB, and wherein the third QoS flow is mapped to a second DRB; and determining the third set of PDCP SDUs as delay-critical PDCP SDUs based on the multi-modal synchronization.

Example 18 includes the method of examples 14-17, wherein the method further comprises: mapping the first QoS flow to a first data radio bearer (DRB); and mapping the second QoS flow to a second DRB.

Example 19 includes a baseband processor comprising: processing circuitry to perform and of the steps of examples 14-18; and interface circuitry coupled with the processing circuitry, the interface circuitry to communicatively couple the processing circuitry with a component of a device.

Example 20 includes one or more computer-readable storage media having instructions that, when executed processing circuitry to perform the steps of any of examples 14-18.

Example 21 includes a method, comprising: determining that a PDU set importance (PSI)-based discarding process activated for a DRB, wherein a first QoS flow and a second QoS flow are mapped to the DRB; receiving a first PDCP SDU belonging to a first QoS flow; receiving a second PDCP SDU belonging to a second QoS flow; determining a first importance associated with the first PDCP SDU; determining a second importance associated with the second PDCP SDU; determining whether the first QoS flow and the second QoS flow are associated with a multi-modal synchronization requirement; selecting a first type of discard timer for the first PDCP SDU and a second type of discard timer the second PDCP SDU; starting a first discard timer for the first PDCP SDU; and starting a second discard timer for the second PDCP SDU, the first discard timer having the first type, and the second discard timer having the second type.

Example 22 includes the method of example 21, wherein the first type of discard timer is a discard timer for PDCP SDUs belonging to important PDU sets, wherein the second type of discard timer is the discard timer for PDCP SDUs belonging to important PDU sets, and wherein the first QoS flow and the second QoS flow are determined to be associated with the multi-modal synchronization requirement, regardless of the first importance and the second importance.

Example 23 includes the method of example 21, wherein the first type of discard timer is a discard timer for PDCP SDUs belonging to important PDU sets, wherein the second type of discard timer is a discard timer for PDCP SDUs belonging to less important PDU sets, and wherein the first QoS flow and the second QoS flow are determined to be associated with the multi-modal synchronization requirement, regardless of the first importance and the second importance.

Example 24 includes the method of example 21, wherein the first type of discard timer is a discard timer for PDCP SDUs belonging to important PDU sets, wherein the second type of discard timer is a discard timer for PDCP SDUs belonging to less important PDU sets, and wherein the first QoS flow and the second QoS flow are determined to be associated with the multi-modal synchronization requirement.

Example 25 includes a baseband processor comprising: processing circuitry to perform and of the steps of examples 21-24; and interface circuitry coupled with the processing circuitry, the interface circuitry to communicatively couple the processing circuitry with a component of a device.

Example 26 includes one or more computer-readable storage media having instructions that, when executed processing circuitry to perform the steps of any of examples 21-24.

Example 27 includes a method, comprising: determining that a PDU set importance (PSI)-based discarding process activated for a DRB, wherein a first QoS flow and a second QoS flow are mapped to the DRB; receiving a first PDCP SDU belonging to a first QoS flow; determining a first importance associated with the first PDCP SDU; selecting a first discard timer for the first PDCP SDU based on the first importance; starting a first discard timer for the first PDCP SDU; receiving a second PDCP SDU belonging to a second QoS flow; determining a second importance associated with the second PDCP SDU; selecting a second discard timer for the second PDCP SDU based on at least one of: whether the first QoS flow and the second QoS flow are associated with a multi-modal synchronization requirement, and or second importance; starting the second discard timer for the second PDCP SDU.

Example 28 includes the method of example 27, mapping the first QOS flow and the second QoS flow to the DRB.

Example 29 includes a baseband processor comprising: processing circuitry to perform and of the steps of examples 27 or 28; and interface circuitry coupled with the processing circuitry, the interface circuitry to communicatively couple the processing circuitry with a component of a device.

Example 30 includes one or more computer-readable storage media having instructions that, when executed processing circuitry to perform the steps of any of examples 27-28.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing first information relating to multi-modal synchronization between a first quality of service (QoS) flow and a second QoS flow;
processing second information indicating whether a packet data unit (PDU) discard is allowed based on a failure of the multi-modal synchronization;
generating, based on the first information and the second information, third information to configure a PDU discard behavior; and
outputting the third information for transmission to a user equipment (UE).

2. The method of claim 1, further comprising:
receiving the second information from a core network (CN) via a policy control function (PCF) or a session management function (SMF).

3. The method of claim 1, further comprising:
receiving the second information from an application function (AF) via a policy control function (PCF) or an SMF.

4. The method of claim 1, further comprising:
receiving first information from a core network (CN).

5. The method of claim 1, further comprising:
receiving the second information via UE assistance information (UAI).

6. The method of claim 1, further comprising:
determining, from the first information, a multi-modal service identifier (ID) associated with both the first QOS flow and the second QOS flow; and
determining the multi-modal synchronization between the first QoS flow and the second QoS flow based on the multi-modal service ID being associated with both the first QoS flow and the second QoS flow.

7. The method of claim 1, wherein the first information is to configure the PDU discard behavior when a failure of the multi-modal synchronization is detected and the PDU discard behavior comprises:
discarding a first PDU packet from the first QoS flow when a PDU packet from the second QoS flow is discarded.

8. The method of claim 1, wherein the first information is to configure the PDU discard behavior when a failure of the multi-modal synchronization is detected and the PDU discard behavior comprises:
continuing a transmission of the PDU packet from the first QoS flow when a PDU packet from the second QoS flow is discarded.

9. The method of claim 1, further comprising:
determining whether to discard a first PDU packet belonging to the first QoS flow or a second PDU belonging to the second QoS flow based on a first importance level of the first PDU packet or a second importance of the second PDU packet.

10. The method of claim 1, further comprising:
mapping the first QoS flow and the second QoS flow to a data radio bearer (DRB); and
configuring the DRB based on the PDU discard behavior.

11. An apparatus comprising:
processor circuitry to:
process first information relating to multi-modal synchronization between a first quality of service (QoS) flow and a second QoS flow;
determine a first set of delay-critical packet data convergence protocol (PDCP) service data units (SDUs) associated with the first QoS flow;
identify a second set of PDCP SDUs associated with the second QoS flow;
determine the second set of PDCP SDUs includes delay-critical PDCP SDUs based on the multi-modal synchronization between the first QoS flow and the second QoS flow; and
output one or more PDCP SDUs of the second set of PDCP SDUs for transmission based on determination that the second set of PDCP SDUs includes delay-critical PDCP SDUs; and
interface circuitry coupled to the processor circuitry to enable communication.

12. The apparatus of claim 11, the processor circuitry further to:
map the first QoS flow and the second QoS flow to a data radio bearer (DRB).

13. The apparatus of claim 11, the processor circuitry further to:
determine that a remaining time until expiration of a discard timer associated with the first set of delay-critical PDCP SDUs is less than a threshold, wherein the UE determines the first set of delay-critical PDCP SDUs based on the remaining time until expiration of the discard timer being less than the threshold.

14. The apparatus of claim 11, the processor circuitry further to:
process second information indicating the multi-modal synchronization between the first QoS flow and a third QoS flow, wherein the third QoS flow is associated with a third set of PDCP SDUs, wherein the first QoS flow and the second QoS flow are mapped to a first DRB, and wherein the third QoS flow is mapped to a second DRB; and
determine the third set of PDCP SDUs as delay-critical PDCP SDUs based on the multi-modal synchronization.

15. The apparatus of claim 11, the processor circuitry further to:
map the first QoS flow to a first data radio bearer (DRB); and
map the second QoS flow to a second DRB.

16. The apparatus of claim 11, wherein the first information is received from a core network (CN).

17. One or more non-transitory, computer-readable media having stored thereon instructions that, when executed, cause one or more processors to:
determine that a packet data unit (PDU) set importance (PSI)-based discarding process activated for a data radio bearer (DRB), wherein a first quality of service (QoS) flow and a second QoS flow are mapped to the DRB;
receive a first packet data convergence protocol (PDCP) service data unit (SDU) belonging to a first QoS flow;
receive a second PDCP SDU belonging to a second QoS flow;
determine a first importance associated with the first PDCP SDU;
determine a second importance associated with the second PDCP SDU;
determine whether the first QoS flow and the second QoS flow are associated with a multi-modal synchronization requirement;
select a first type of discard timer for the first PDCP SDU and a second type of discard timer the second PDCP SDU;
start a first discard timer of the first type for the first PDCP SDU; and
start a second discard timer of the second type for the second PDCP SDU.

18. The one or more non-transitory, computer-readable media of claim 17, wherein the first type of discard timer is a discard timer for PDCP SDUs belonging to important PDU sets, wherein the second type of discard timer is the discard timer for PDCP SDUs belonging to important PDU sets, and wherein the first QoS flow and the second QoS flow are determined to be associated with the multi-modal synchronization requirement, regardless of the first importance and the second importance.

19. The one or more non-transitory, computer-readable media of claim 17, wherein the first type of discard timer is a discard timer for PDCP SDUs belonging to important PDU sets, wherein the second type of discard timer is a discard timer for PDCP SDUs belonging to less important PDU sets, and wherein the first QoS flow and the second QoS flow are determined to be associated with the multi-modal synchronization requirement, regardless of the first importance and the second importance.

20. The one or more non-transitory, computer-readable media of claim 17, wherein the first type of discard timer is a discard timer for PDCP SDUs belonging to important PDU sets, wherein the second type of discard timer is a discard timer for PDCP SDUs belonging to less important PDU sets, and wherein the first QoS flow and the second QoS flow are determined to be associated with the multi-modal synchronization requirement.
